(19) United States
(12) Patent Application Publication
(10) Pub. No.: US 2007/0018562 A1
(43) Pub. Date: Jan. 25, 2007

(54) Field emitter arrangement and method of cleansing an emitting surface of a field emitter

(75) Inventors: Pavel Adamec, Haar (DE); Fang Zhou, Pliening/Landsham (DE)

Correspondence Address: PATTERSON & SHERIDAN, L.L.P., 3040 POST OAK BOULEVARD, SUITE 1500, HOUSTON, TX, 77056, US

(73) Assignee: ICT Integrated Circuit Testing Gesellschaft fur Halbleiterpruftechnik mbH

(21) Appl. No.: 11/489,979

(22) Filed: Jul. 20, 2006

(30) Foreign Application Priority Data
Jul. 22, 2005 (EP) 05015981.3

(51) Int. Cl. H01J 1/02

(52) U.S. Cl. 313/495; 313/306; 313/309

(57) ABSTRACT

A field emitter arrangement and a method of cleaning an emitting surface of a field emitter are provided. The field emitter arrangement may include a field emitter tip having an emitting surface, wherein said field emitter tip is adapted to generate a primary beam of charged particles, and at least one electron source adapted to illuminate the emitting surface of the field emitter tip. The method of cleaning the emitting surface may include providing the field emitter having the emitting surface and at least one electron source adapted to illuminate the emitting surface and illuminating the emitting surface of the field emitter with a cleansing electron beam generated by the at least one electron source.

### CROSS-REFERENCE TO RELATED APPLICATION

This application claims priority to European Patent Application No. 05015981.3 filed Jul. 22, 2005, which is herein incorporated by reference.

### FIELD OF THE INVENTION

Embodiments of the present invention relate to a field emitter arrangement, as well as to a method of cleansing an emitting surface of a field emitter.

### BACKGROUND OF THE INVENTION

Technologies like microelectronics, micromechanics, and biotechnology have created a high demand in industry for structuring and probing specimens within the nanometer scale. On such a small scale, probing or structuring (e.g., of photomasks) is often done with electron beams, which are generated and focused in electron beam devices, such as electron microscopes or electron beam pattern generators. Electron beams offer superior spatial resolution compared to, for example, photon beams due to their short wave lengths at a comparable particle energy.

The first step in creating images with any electron microscope is the production of an electron beam. The electron beam is generated in a device generally known as an electron gun. Three major types of electron guns are used in electron microscopes: tungsten-hairpin filament guns, lanthanum-hexaboride guns, and field-emission guns. Field-emission guns offer several advantages over tungsten-hairpin filament guns or lanthanum-hexaboride guns. First, the brightness may be up to a thousand times greater than that of a tungsten gun. Second, the electrons are emitted from a point more narrow than that in the other sources. Thus, superior resolution is achieved by field-emission guns. Furthermore, the energy spread of the emitted electrons is comparatively small. Finally, the field-emission gun has a very long lifetime. For these reasons, the field-emission gun is the preferred choice for a number of applications.

There exist three major types of field emission guns: cold field emission guns, thermal field emission guns, and Schottky emitters. While cold field emission guns rely on the pure field emission effect, thermal field emission guns enhance the pure field emission effect by supplying some thermal energy to the electrons in the metal, so that the required tunneling distance is shorter for successful escape from the surface. A Schottky emitter is a thermal field emitter that has been further enhanced by doping the surface of the emitter to reduce the work function.

The cold field emitter tip has the highest brightness of presently known emitters and is therefore the preferred choice for obtaining the highest possible electron density in the smallest spot. Thus, electron microscopes equipped with cold cathode emitters are superbly suited to obtain high resolution, high quality images, especially at very low acceleration voltages. Additional advantages of cold emitters include their ease of use and long lifetime, which reduces the cost of ownership.

However, during operation continual adsorption and occasional desorption of residual gas molecules occurs on the emitting surface of cold field electron emitters. These adsorptions and desorptions lead to continuously degraded and momentarily instable emission current, respectively, so that the emitting surface has to be cleaned in regular intervals. Conventionally, this is done by a so-called “flashing” method. According to the flashing method, a heating current is supplied to the emitter so that the emitting surface heats up and debris is removed from the surface. Heating the tip momentarily (flashing) can clean it, but new atoms and molecules quickly readsorb even in the best of vacuums. In addition, atoms may be ionized by the electron beam and subsequently accelerated back into the tip, causing physical sputtering of the tip itself. To minimize the current fluctuations, the electron source must be operated in an extreme ultra high vacuum environment (e.g., 10⁻¹⁰ Torr or better). Furthermore, the use of the electron microscope has to be suspended during the flashing process which may take a few minutes or even longer. This reduces the effective working time of the microscope and is especially undesirable in high throughput applications such as wafer inspection or the like.

### SUMMARY OF THE INVENTION

In view of the above, a field emitter arrangement including a field emitter with an emitting surface, said field emitter being adapted to generate a primary beam of charged particles, and at least one electron source adapted to illuminate the emitting surface of the field emitter are provided. Also, a charged particle beam apparatus including such a field emitter arrangement is provided. Furthermore, a method of cleaning an emitting surface of a field emitter is provided, the method including the steps of providing a field emitter with an emitting surface and an electron source adapted for illuminating the emitting surface, and illuminating the emitting surface of the field emitter with an electron beam generated by the electron source.

Further advantages, features, aspects and details of the invention are evident from the claims, the description and the accompanying drawings.

### BRIEF DESCRIPTION OF THE DRAWINGS

Some of the above indicated and other more detailed aspects of the invention will be described in the following description and partially illustrated with reference to the figures. Therein:

FIG. 1 shows a field emitter arrangement according to an embodiment of the present invention;

FIG. 2 shows a field emitter arrangement according to another embodiment of the present invention;

FIG. 3 shows the field emitter arrangement of FIG. 2 in another mode of operation;

FIG. 4 shows a field emitter arrangement according to an embodiment of the present invention, wherein a focusing lens is provided;

FIG. 5 shows a field emitter arrangement according to an embodiment of the present invention having a plurality of electron sources;

FIG. 6 shows a field emitter arrangement according to an embodiment of the present invention, wherein a beam separation device is provided;

FIG. 7 shows a field emitter arrangement according to an embodiment of the present invention, wherein an energy filter is provided; and

FIG. 8 shows a charged particle beam apparatus with a field emitter arrangement according to an embodiment of the present invention.

### DETAILED DESCRIPTION OF THE DRAWINGS

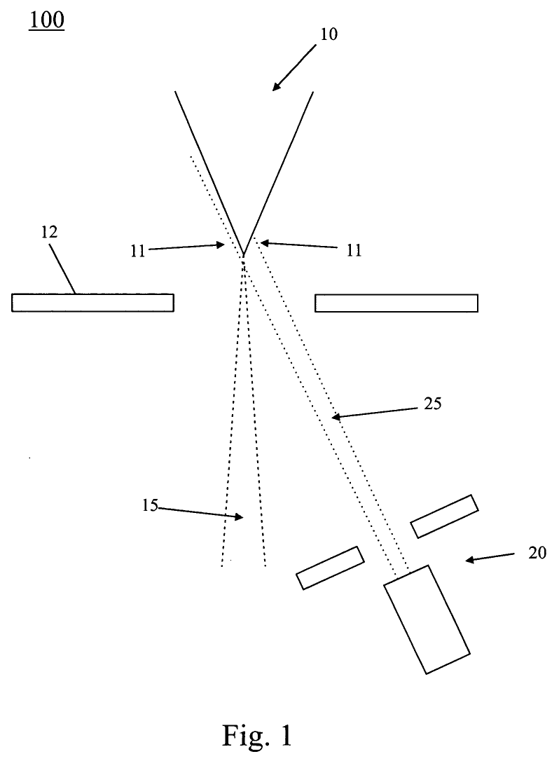

FIG. 1 shows a field emitter arrangement 100 according to an embodiment of the present invention. Therein, an emitter tip 10 of a field emission gun may be provided. The emitter tip 10 may comprise an emitting surface 11 from which the charged particles, such as electrons as described herein, may be emitted. Furthermore, an extraction electrode 12 may be arranged near the emitter tip 10. A voltage difference may be applied between the extraction electrode 12 and the emitter tip 10. Due to the sharply pointed shape of the emitter tip 10, very high field strengths may build up at the pointed tip end of the emitter. The field strength may be high enough to continuously extract electrons from the emitter tip 10 so that they form an electron beam 15. The electron beam 15 may be used, for example, in wafer inspection or electron beam lithography processes.

According to the embodiment of the present invention shown in FIG. 1, an electron source 20 may be provided. Electron source 20 may be realized by a cold field emitter, a thermal field emitter, or any other kind of electron source. Electron source 20 may be adapted to illuminate the emitting surface 11 of the emitter tip 10 with an electron beam 25. The electron beam 25 enters into the emitter through the main aperture of the extraction electrode 12. Since electrons can be used to desorb atoms and/or molecules adsorbed at the emitting surface 11, the illumination of the emitting surface 11 with electrons generated by electron source 20 may cause desorption of the adsorbed atoms and/or molecules. Thus, the emitting surface 11 may be cleansed, and stable emission of the electron beam 15 may be provided. Furthermore, electron source 20 may be continuously operated so that the operation of the charged particle beam apparatus may not have to be suspended for the cleansing operation.

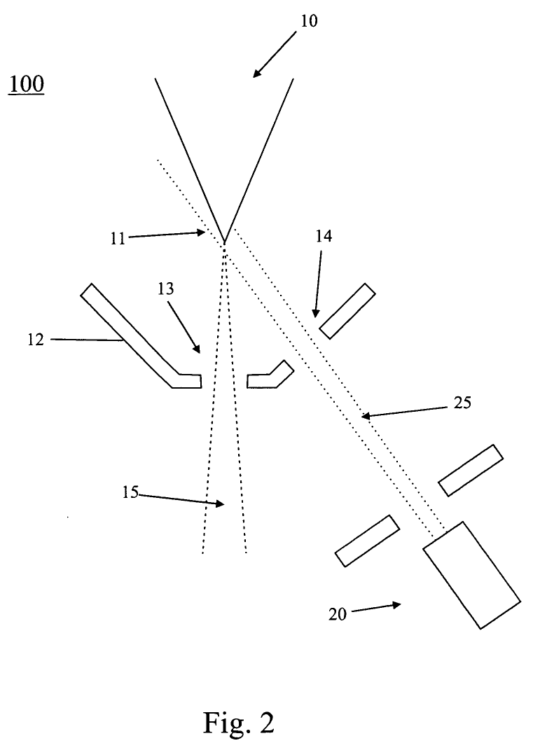

FIG. 2 shows a field emitter arrangement 100 according to another embodiment of the present invention. Therein, the extraction electrode 12 of the cold field emitter 10 may have a main opening 13 for the primary electron beam 15 and an additional opening 14 for the cleansing electron beam 25. Opening 14 may be located laterally with respect to the opening 13 for the primary electron beam 25. Furthermore, opening 14 should be disposed between the electron source 20 and the emitting surface 11 of the field emitter such that the line of sight between the electron source 20 and the emitting surface 11 is not obstructed. Cleansing electron beam 25 may be generated by electron source 20 and may reach the cold field emitter 10 through opening 14. Since opening 14 may be located laterally with respect to the main opening 13 and disposed between the electron source 20 and the emitting surface 11, the cleansing beam 25 may also reach the emitter 10 laterally and impinge onto the emitting surface 11 from a lateral direction. In this manner, interaction between the primary electron beam 15 and the cleansing electron beam 25 may be reduced. Furthermore, the main opening 13 may be kept relatively small.

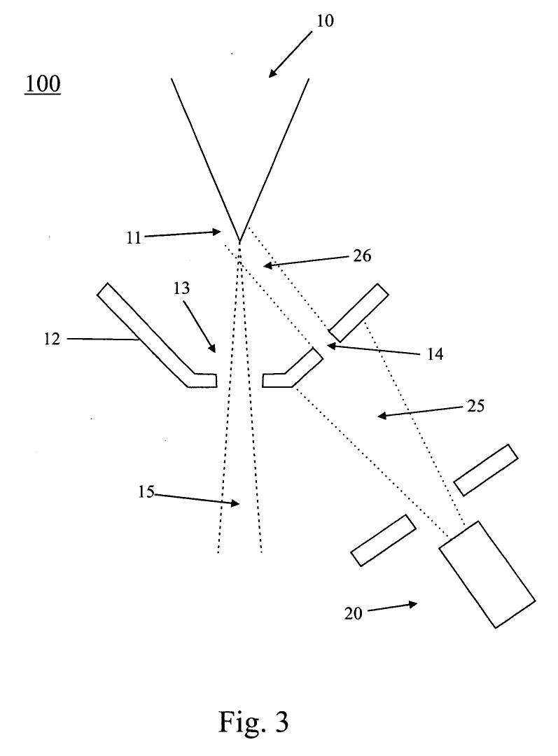

FIG. 3 shows another embodiment of the present invention. Therein, the additional opening 14 may be used as an aperture for the cleansing electron beam 25. Therefore, additional opening 14 may be smaller than in the embodiment shown in FIG. 2. By using opening 14 as an aperture, the cross section of the cleansing beam 26 behind opening 14 and at the emitting surface 11 may be reduced so that essentially only a portion the emitter tip 11 is illuminated by cleansing beam 26.

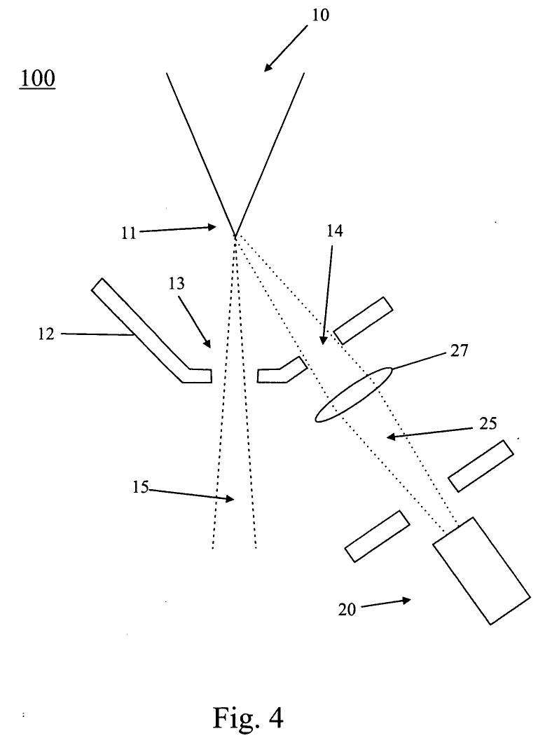

A further embodiment of the present invention is shown in FIG. 4. Therein, a lens 27 may be disposed between electron source 20 and opening 14 in an effort to focus cleansing electron beam 25 on the tip portion of field emitter 10. In this manner, the full beam current density generated by electron source 20 may be used for cleaning the emitter tip 10. Optionally, lens 26 may be supplemented or even replaced by a deflector (not shown). Such a deflector may be used to accurately position cleansing electron beam 25 on the emitter tip 10. Although described with respect to the embodiment shown in FIG. 4, it should be understood that lens 26 or the deflector may also be added individually or together to the embodiments shown in FIGS. 1, 2, 5, 6, 7, and 8.

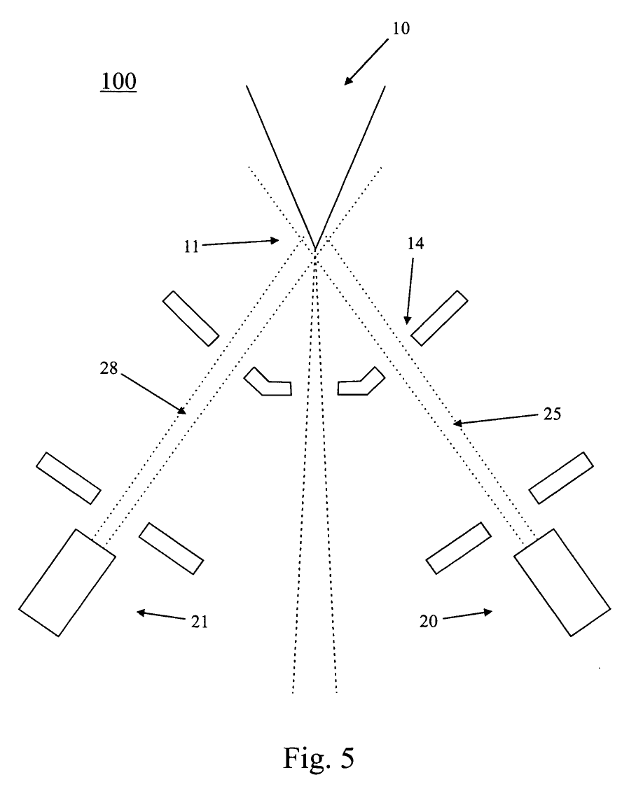

An improved embodiment of the present invention is shown in FIG. 5. Therein, a cross section of a field emitter arrangement 100 having a plurality of electron sources is shown. Compared to the embodiment shown in FIG. 2, the embodiment shown in FIG. 5 may comprise a further electron source 21 which may be arranged opposite to the first electron source 20 with respect to the field emitter 10. The extraction electrode of the field emitter 10 may have a further opening disposed between the second electron source 21 and the emitting surface 11. A further cleansing electron beam 28 may be generated by the second electron source 21 and enter into the field emitter 10 through the further opening in the extraction electrode. Because the further electron source 21 may be disposed opposite to the first electron source 20, the second electron beam may impinge essentially on the opposite side of the emitting surface 11 compared to the first cleansing electron beam 25. In this manner, the illumination uniformity on the emitting surface 11 should be improved. In addition to the embodiment described above, even further electron sources may be provided, for example, above and below the planar cross section depicted in FIG. 5. Typically, the plurality of electron sources may be arranged on a ring around the field emitter 10. Furthermore, the electron sources may be evenly spaced on this ring in an effort to further improve illumination uniformity.

Alternatively, a ring-shaped electron source (not shown) may be disposed around field emitter 10. For example, the ring-shaped source may comprise a metal ring which is resistively heated so that thermal electron emission occurs. However, other suitable ring-shaped electron sources may be provided. Due to its ring shape, such an emitter may provide uniform illumination of the emitting surface 11 of field emitter 10.

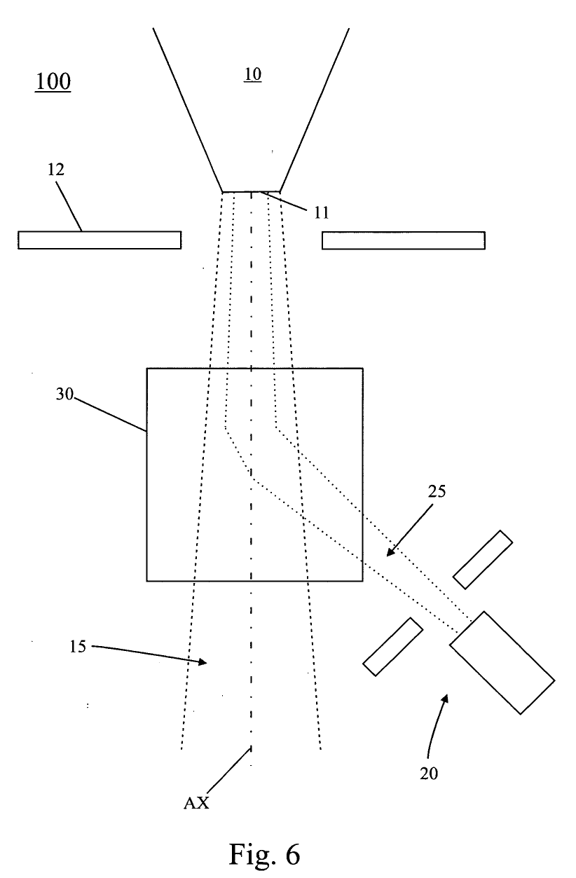

FIG. 6 shows a field emitter arrangement 100 according to a different embodiment of the present invention that may comprise a beam separation device 30. The beam separation device 30 may be adapted to redirect the cleansing electron beam 25 onto the emitting surface 11 of the field emitter 10. The beam separation device 30 can be realized by a magnetic dipole, a magnetic sector field of a Wien filter, or any other suitable means. The beam separation device 30 may be configured such that it influences essentially only the cleansing beam 25, but not the primary electron beam 15. The cleansing electron beam 25 may be generated by an electron source 20 located laterally with respect to the field emitter 10. Accordingly, the cleansing electron beam 25 may laterally enter into the beam separation device 30. Within the beam separation device 30, the cleansing electron beam 25 may be redirected in a direction coaxial with the emission axis AX of the field emitter 10. The redirected cleansing beam 25 may enter the emitter through the opening for the primary beam 15 and may impinge essentially normal to the emitting surface 11. Thus, only the emitting portion of field emitter 10 may be illuminated so that the beam current density of cleansing beam 25 may be kept small. Furthermore, beam separation device 30 may allow full control of cleansing electron beam 25 so that the redirected beam 25 can be focused and accurately positioned on the emitter tip.

For example, when a Wien filter is used as a beam separation device, the dipole fields of the Wien filter may substantially cancel each other for the primary electron beam 15. Therefore, the primary beam 15 may only be weakly influenced by the Wien filter. However, since the electrons of cleansing beam 25 may travel in a direction opposite to the direction of the electrons in primary beam 15 for some embodiments, the dipole fields of the Wien filter should add together and strongly influence cleansing beam 25. Thus, cleansing beam 25 may be effectively controlled by the Wien filter without interfering with primary beam 15.

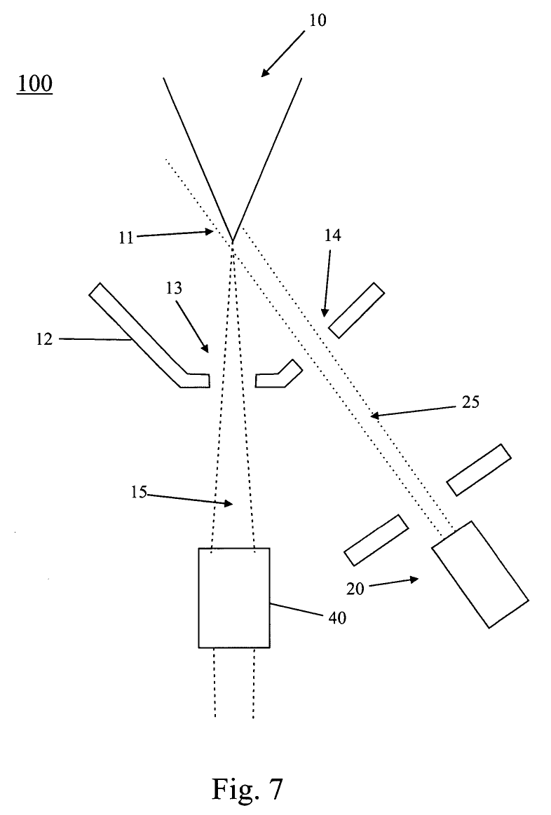

FIG. 7 shows a field emitter arrangement 100 according to a further embodiment of the present invention. Therein, an energy filter 40 may be provided. Such an energy filter 40 may be realized, for example, by a Wien filter. Some of the electrons contained in the cleansing beam 25 may produce secondary electrons at the emitting surface 11. However, such secondary electrons may typically have a higher energy and broader energy distribution than the field emitted electrons produced by field emitter 10. Therefore, they may be easily separated from the primary electron beam 15 by means of the energy filter 40.

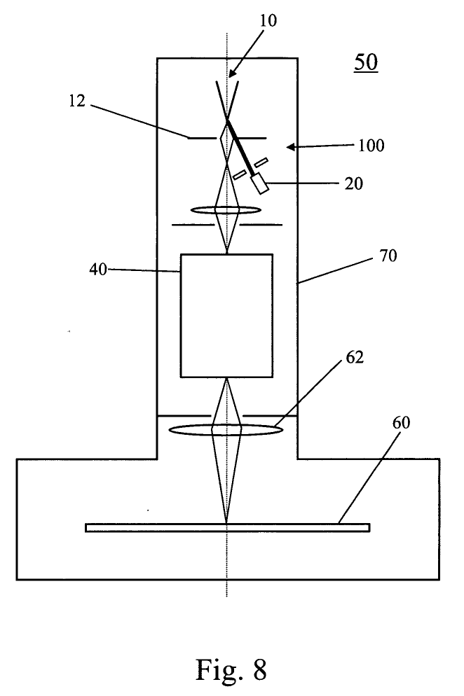

FIG. 8 shows a charged particle apparatus equipped with an emitter arrangement 100 according to an embodiment of the present invention. Therein, the field emission gun 10, 12, the electron source 20, the energy filter 40, and a specimen 60 to be inspected may be disposed within a vacuum-tight column 70. The field emission gun 10, 12 may generate an electron beam that may be focused onto the specimen 60 by electron optical lenses 62. During operation of the field emission gun 10, 12, the electron source 20 may illuminate the emitting surface 11 of the emitter tip so that adsorbed atoms and/or molecules desorb therefrom. Thus, continuous cleansing of the emitting surface and, accordingly, continuous stable emission of the field emitter should be provided.

Having thus described embodiments of the invention in detail, it should be apparent for a person skilled in the art that various modifications may be made in embodiments of the present invention without departing from the spirit and scope of the following claims:

1. A field emitter arrangement, comprising:
a field emitter having an emitting surface, said field emitter being adapted to generate a primary beam of charged particles, and
at least one electron source adapted to illuminate the emitting surface of the field emitter.

2. The field emitter arrangement of claim 1, wherein the at least one electron source is a ring-shaped emitter around an extractor electrode of the field emitter.

3. The field emitter arrangement of claim 1, wherein the at least one electron source comprises a concentrated electron emitter.

4. The field emitter arrangement of claim 3, wherein an extractor electrode of the field emitter has an opening located between the concentrated electron emitter and the emitting surface of the field emitter.

5. The field emitter arrangement of claim 3, further comprising at least one further concentrated electron emitter.

6. The field emitter arrangement of claim 5, wherein the extractor electrode comprises a further opening located between the at least one further concentrated emitter and the emitting surface of the field emitter.

7. The field emitter arrangement of claim 5, wherein a plurality of electron emitters is arranged in a ring-like pattern around the emitting surface.

8. The field emitter arrangement of claim 1, wherein the at least one electron source and the field emitter are integrated to form a single component.

9. The field emitter arrangement of claim 1, being further adapted such that an electron beam generated by the at least one electron source impinges on the emitting surface in a direction essentially normal to the emitting surface.

10. The field emitter arrangement of claim 9, further comprising a beam separation device configured to redirect the electron beam generated by the at least one electron source.

11. The field emitter arrangement of claim 10, wherein the beam separation device is configured to redirect the electron beam such that the electron beam is essentially coaxial with an emission axis of the field emitter.

12. The field emitter arrangement of claim 1, wherein the electron source is a thermal emitter, a cold field emitter, or a photo emitter.

13. The field emitter arrangement of claim 1, wherein the at least one electron source is controllable so that the average electron energy within the electron beam generated by the at least one electron source is variable.

14. The field emitter arrangement of claim 1, wherein the beam current density of a secondary electron beam generated by the at least one electron source is adapted such that a production rate of secondary electrons generated by the secondary beam is lower than a rate of field-emitted electrons generated by the field emitter.

15. The field emitter arrangement of claim 1, further comprising an energy filter for removing secondary electrons generated at the emitting surface by a secondary electron beam generated by the at least one electron source from the primary beam generated by the field emitter.

16. The field emitter arrangement of claim 15, wherein a beam separation device configured to redirect the secondary electron beam generated by the at least one electron source and the energy filter are integrally formed.

17. The field emitter arrangement of claim 1, wherein the field emitter is a member of a field emitter array.

18. A charged particle beam apparatus, comprising:
a field emitter arrangement, comprising:
a field emitter having an emitting surface, said field emitter being adapted to generate a primary beam of charged particles, and
at least one electron source adapted to illuminate the emitting surface of the field emitter.

19. The apparatus of claim 18, further comprising an energy filter for removing secondary electrons generated at the emitting surface by a secondary electron beam generated by the at least one electron source from the primary beam generated by the field emitter.

20. The apparatus of claim 18, further comprising at least one electron optical lens configured to focus the primary beam on a specimen.

21. The apparatus of claim 18, wherein the field emitter arrangement is disposed within a vacuum-tight entity.

22. A method of cleaning an emitting surface of a field emitter, comprising:
(a) providing the field emitter having the emitting surface and at least one electron source adapted to illuminate the emitting surface, and
(b) illuminating the emitting surface of the field emitter with a cleansing electron beam generated by the at least one electron source.

23. The method according to claim 22, further comprising removing photo-emitted electrons from an electron beam generated by the field emitter.

24. The method according to claim 22, further comprising adjusting the beam current density of the cleansing electron beam generated by the at least one electron source such that a production rate of secondary electrons generated by the cleansing electron beam is lower than a rate of field-emitted electrons generated by the field emitter.
